(19) United States
(12) Patent Application Publication
(10) Pub. No.: US 2021/0191751 A1
(43) Pub. Date: Jun. 24, 2021

(54) METHOD AND DEVICE FOR ALLOCATING RESOURCE IN VIRTUALIZED ENVIRONMENT

(71) Applicants: SAMSUNG ELECTRONICS CO., LTD., Suwon-si, Gyeonggi-do (KR); KOREA UNIVERSITY RESEARCH AND BUSINESS FOUNDATION, Seoul (KR)

(72) Inventors: Jiehwan PARK, Suwon-si, Gyeonggi-do (KR); Kyoungwoon LEE, Seoul (KR)

(21) Appl. No.: 17/251,036

(22) PCT Filed: May 24, 2019
(86) PCT No.: PCT/KR2019/006260

§ 371 Date: Dec. 10, 2020

(30) Foreign Application Priority Data
Jun. 11, 2018 (KR) 10-2018-0067032

(51) Int. Cl. G06F 9/455; G06F 9/50

(52) U.S. Cl. CPC G06F 9/45558; G06F 9/5011; G06F 2009/45562; G06F 2009/4557; G06F 2009/45595; G06F 9/5027

(57) ABSTRACT

According to one aspect, a host device for dynamically allocating resources to a plurality of virtualized containers may include a user interface for receiving a user input requesting to allocate resources to a plurality of containers; a calculator for calculating weights of the plurality of containers, based on the user input, calculating the resources to be allocated to the plurality of containers, based on the weights, allocating the calculated resources to the plurality of containers, and dynamically recalculating resources to be allocated to the plurality of containers by reflecting the amounts of resources used by the plurality of containers; and a scheduler for monitoring the amount of resources used when services are provided by the plurality of containers.

### TECHNICAL FIELD

One aspect relates to a technology for dynamically allocating network resources in a container virtualization environment.

### BACKGROUND ART

Virtualization of devices is one of technologies for more efficient use of a server having limited physical resources as information and communication technology has developed. A server to which virtualization is applied is capable of processing data, which is requested by numerous users, with limited resources, based on the fact that the server is not accessible by all the users at the same time, and therefore, the demand therefor is increasing.

As device virtualization methods, there are a virtual machine method of virtualizing, with software, a server having its performance fixed in terms of hardware, and a container method of virtualizing only a certain process environment processed by a server.

In a general virtualization environment, when multiple containers operate simultaneously, computing resources such as a central processing unit (CPU) and a network are equally allocated to the containers. However, when resources are equally allocated, resource allocation cannot be performed according to characteristics of services when the containers perform services having different characteristics, and thus, a change of the amount of resources used cannot be reflected. In an Internet-of-Things (IoT) environment, a variety of services are provided and characteristics of a provided service change with time and therefore there is a growing need to allocate resources to containers in consideration of a dynamic environment.

### DESCRIPTION OF EMBODIMENTS

### Technical Problem

Provided is a network virtualization device and method for dynamically allocating resources to a plurality of containers in consideration of network performance of a plurality of containers providing different services in an IoT environment.

### Technical Solution to Problem

In a first embodiment, a host device for dynamically allocating resources to a plurality of virtualized containers is provided. The host device includes: a user interface configured to receive a user input requesting to allocate resources to the plurality of containers; a calculator configured to calculate weights of the plurality of containers, based on the user input, calculate resources to be allocated to the plurality of containers, based on the weights, allocate the calculated resources to the plurality of containers, and dynamically recalculate resources to be allocated to the plurality of containers by reflecting amounts of resources used by the plurality of containers; and a scheduler configured to monitor an amount of resources used when services are provided by the plurality of containers.

In a second embodiment, a host device for dynamically allocating resources to a plurality of virtualized containers is provided. The host device includes: a user interface configured to receive a user input requesting to allocate resources to the plurality of containers; and a processor configured to calculate weights of the plurality of containers, based on the user input, calculate resources to be allocated to the plurality of containers, based on the weights, allocate the calculated resources to the plurality of containers, dynamically recalculate resources to be allocated to the plurality of containers by reflecting amounts of resources used by the plurality of containers, and monitor an amount of resources used when services are provided by the plurality of containers.

In a third embodiment, a method of dynamically allocating resources by a host device including a plurality of virtualized containers includes: receiving a user input requesting to allocate resources to the plurality of containers; calculating weights of the plurality of containers, based on the user input, and calculating resources to be allocated to the plurality of containers, based on the weights; allocating the calculated resources to the plurality of containers; monitoring an amount of resources used when services are provided by the plurality of containers; and dynamically recalculating resources to be allocated to the plurality of containers by reflecting amounts of resources used by the plurality of containers.

In a fourth embodiment, there is provided a computer program product including a recording medium storing a program to perform: obtaining, by a multilingual translation model, a multilingual sentence; and obtaining vector values corresponding to words included in the multilingual sentence, converting the obtained vector values into vector values corresponding to a target language, and obtaining a sentence in the target language, based on the resultant vector values.

### BRIEF DESCRIPTION OF DRAWINGS

Embodiments will be easily understood from the following detailed description in conjunction with the accompanying drawings, and reference numerals denote structural elements.

FIG. 1 is a diagram schematically illustrating a device for dynamically allocating resources in a virtualization environment with a plurality of containers, according to an embodiment.

FIG. 2 is a flowchart of a method of allocating resources in a virtualization environment, according to an embodiment.

FIG. 3 is a diagram for explaining a container network mode in an Internet-of-Things (IoT) environment, according to an embodiment.

FIG. 4 is a diagram for explaining operations of a host device and a container device, according to an embodiment.

FIG. 5 is a flowchart of operations of a calculator to allocate credits, according to an embodiment.

FIG. 6 is a flowchart of resource reallocation according to usage of resources of a container, according to an embodiment.

FIG. 7 is a diagram for explaining reallocation of resources when the amount of resources used by a plurality of containers is less than that of resources allocated thereto, according to an embodiment.

FIG. 8 is a diagram for explaining reallocation of resources when the amount of resources used by a plurality of containers is greater than that of resources allocated thereto, according to an embodiment.

FIG. 9 is a diagram for explaining an operation of a scheduler according to an embodiment.

### MODE OF DISCLOSURE

In embodiments of the disclosure, general terms that have been widely used nowadays are selected, if possible, in consideration of functions of the disclosure, but non-general terms may be selected according to the intentions of technicians in the this art, precedents, or new technologies, etc. Some terms may be arbitrarily chosen by the present applicant, and in this case, the meanings of these terms will be explained in corresponding parts of embodiments in detail. Accordingly, the terms used herein should be defined not based on the names thereof but based on the meanings thereof and the whole context of the disclosure.

As used herein, the singular expressions are intended to include plural forms as well, unless the context clearly dictates otherwise. Terms used herein, including technical or scientific terms, may have the same meaning as commonly understood by those of ordinary skill in the technical field described herein.

It will be understood that when an element is referred to as “including” another element, the element may further include other elements unless mentioned otherwise. Terms such as “unit”, “module,” and the like, when used herein, represent units for processing at least one function or operation, which may be implemented by hardware, software, or a combination of hardware and software.

The expression “configured to” used herein may be interchangeably used, for example, “suitable for”, “having the capacity to”, “designed to”, “adapted to”, “made to”, or “capable of”, depending on a situation. The expression “configured to” may not be necessarily understood only as “specifically designed to” in terms of hardware. Instead, in some situations, the expression “system configured to ˜” may be understood to mean the system “to be configured to ˜” together with other devices or components. For example, the phrase “processor configured to perform A, B, and C” may be understood to mean a dedicated processor (e.g., an embedded processor) for performing a corresponding operation or a generic-purpose processor (e.g., a CPU or an application processor) capable of executing one or more software programs stored in a memory to perform corresponding operations.

A virtual machine according to an embodiment is a computing environment implemented by software, in which a physical computer may be multiplexed to provide a complete system platform, thereby executing a complete operating system.

A container according to an embodiment is a form of virtualization and is an example of process virtualization. Virtualization technology using containers refers to a technology for allocating and sharing hardware resources to be used for each user process by dividing the inside of a host operating system (OS) into a kernel space for managing physical resources and a user space for executing a user process, i.e., an application program (APP), and dividing the user space into several parts.

Container refers to a lightweight OS virtualization method that does not use a hypervisor (hardware emulator) and a guest OS, consumes little host resources and requires very little startup time and thus is suitable for application virtualization. Owing to virtualization in an OS, an existing physical server (bare metal), a virtual server (virtual machine) and the like may be configured and distributed independently of infrastructure.

In one embodiment, core technologies used for containers are control groups (Cgroups) and Namespace of Linux. Container refers to an independent system that is configured to allocate resources to an application process through Cgroups and is virtualized in an OS isolated through Namespace. Namespace is a technology for isolating a process, a network, a mount or the like in a certain name space.

A container may allocate computing resources to each application by using Cgroups according to a resource allocation policy. Cgroups may create a process group and allocate and manage resources to allocate host resources to a process in an OS. A host device may allocate computing resources to each application by using Cgroups according to a set resource allocation policy. Cgroups may control resources to allocate computing resources in Linux to each application. Accordingly, the container may limit CPU usage, memory usage, etc. by using Cgroups of a Linux kernel and thus it is possible to control compiling errors due to problems that may occur during execution of an application and accurately execute the application. In one embodiment, work-conserving refers to entering an idle state only when there are no jobs to be processed.

In one embodiment, server consolidation refers to an approach to reducing the total number of operating servers and preventing low-utilization servers from taking up a lot of space. Server consolidation makes it to efficiently operate resources, thereby reducing costs.

In one embodiment, a hypervisor is a software layer for configuring a virtualization system. The hypervisor may be present between an operating system and hardware and provide logically separate hardware to each virtual machine. The hypervisor may create and manages a number of containers, and various virtualization methods such as full virtualization and semi-virtualization methods are applicable thereto. For example, the hypervisor may be implemented as a Linux kernel-based virtual machine (KVM) and replaced with another hypervisor that provides actions/effects equivalent or similar to those of the KVM.

In one embodiment, a computer system includes, for example, but is not limited to, a desktop personal computer (PC), a laptop PC, a netbook computer, a workstation, a server, a personal digital assistant (PDA), and the like. In one embodiment, the computer system may include at least one of a smart phone, a tablet PC, a mobile phone, a video phone, an e-book reader, a portable multimedia player (PMP), and an MP3 player, a mobile medical device, a camera, or a wearable device.

Embodiments of the disclosure will be described in detail with reference to the accompanying drawings below so that they may be easily implemented by those of ordinary skill in the art. However, the disclosure may be embodied in many different forms and is not limited to the embodiments of the disclosure set forth herein.

Hereinafter, embodiments of the disclosure will be described in detail with reference to the accompanying drawings.

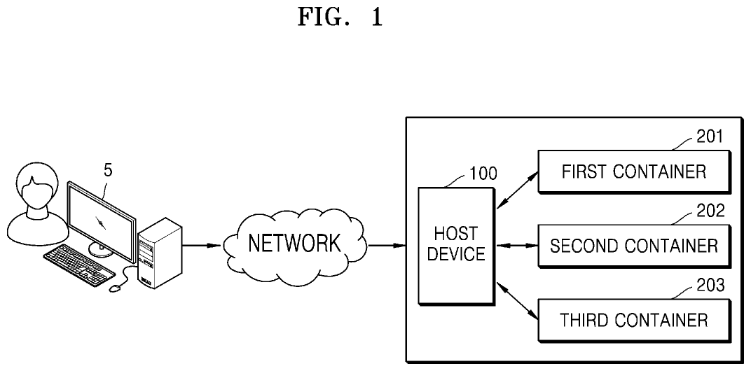

FIG. 1 is a diagram schematically illustrating a device for dynamically allocating resources in a virtualization environment with a plurality of containers, according to an embodiment.

In one embodiment, a host device 100 may include a plurality of virtualization containers. The host device 100 may communicate with a computer system 5 through a network. A user may create a container and the host device 100 by using the computer system 5 and transmit information for resource allocation.

The host device 100 refers to a physical server to which virtualization is applied by a user. The host device 100 processes and stores various types of information, which is supplied to the host device 100 through a wired or wireless communication network, according to characteristics of information.

A user may apply virtualization to the host device 100 in a container manner through the computer system 5, and an upper limit of the performance of a container, which is a virtualized device, is equal to a level of the performance of the host device 100. For example, when the host device 100 is a server equipped with an octa-core CPU, a CPU of a virtual machine implemented in the host device 100 should not exceed octa core performance.

A first container 201, a second container 202, and a third container 203, which are virtualized devices, are devices implemented in software by applying virtualization to the host device 100 by a user.

Referring to FIG. 1, there are only three virtualized devices in the host device 100, but the number of virtualized devices is set to three for convenience of explanation and may be less than or greater than three in an embodiment. The first container 201, the second container 202, and the third container 203 implemented in the host device 100 may all be implemented by a container virtualization method.

In one embodiment, the amounts of resources of the first container 201, the second container 202, and the third container 203 should not exceed a maximum amount of resources of the host device 100 but the sum of the amounts of the resources of the first container 201, the second container 202, and the third container 203 may exceed the maximum amount of resources of the host device 100. Resources are over-committed to the first container 201, the second container 202, and the third container 203 to increase efficiency of work processed by the first container 201, the second container 202, and the third container 203 because the first container 201, the second container 202, and the third container 203 do not always operate using all resources. Because the amount of resources allocated to and used by the first container 201, the second container 202 and the third container 203 is implemented in software within basic performance of the host device 100 according to the virtualization technology, resources may be over-committed to the virtualized devices 201, 202, and 203.

In one embodiment, the first container 201, the second container 202, and the third container 203 are devices implemented in the host device 100 and may exchange various types of data with the host device 100. The first container 201, the second container 202, and the third container 203 are logical devices implemented in the host device 100 and thus the host device 100 is capable of identifying each virtualized device. In addition, at least one virtualized device among the already implemented first container 201, second container 202, and third container 203 may be isolated from the host device 100 and thereafter migrated to another host device different from the host device 100.

In one embodiment, the first container 201, the second container 202 and the third container 203 may independently process various types of data, based on the amount of resources allocated within a maximum resource range of the host device 100 and are influenced by a process occurring in the host device 100 or other virtualized container. For example, when a virtualized device tries to process new data according to a user input, data processing may not be performed by the virtualized device when the amount of resources used by remaining virtualized devices other than the virtualized device exceeds the maximum amount of resources of the host device 100. In this situation, the host device 100 may have an adjustment function of enabling all virtualized devices defined in the host device 100 to process data in parallel.

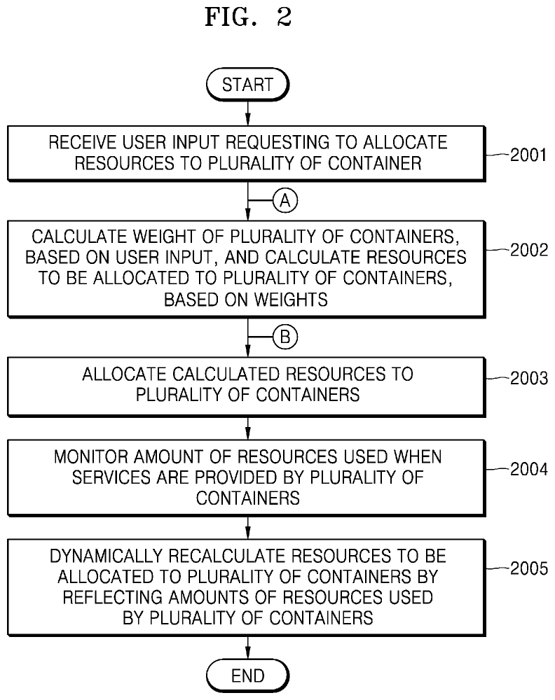

FIG. 2 is a flowchart of a method of allocating resources in a virtualization environment, according to an embodiment.

In one embodiment, a method of dynamically allocating resources by a host device including a plurality of virtualized containers may be provided. In one embodiment, the method may be performed in the host device.

In a block 2001, the host device according to an embodiment may receive a user input requesting to allocate resources to a plurality of containers. In one embodiment, the host device may receive a user input regarding a performance ratio between containers, a minimum performance level, and a maximum performance level.

Alternatively, the host device may receive a user input including a percentage of a performance ratio of a new container, an absolute value of minimum performance of the new container, and an absolute value of maximum performance of the new container, when the new container has been created.

In a block 2002, the host device according to an embodiment may calculate weights of the plurality of containers, based on the user input, and calculate resources to be allocated to the plurality of containers, based on the weights.

In one embodiment, the host device may determine the absolute value of the minimum performance level, which is included in the user input, as a minimum value, and the absolute value of the maximum performance level, which is included in the user input, as a maximum value. For example, when container performance of a Raspberry Pi 3 board with maximum performance of 20 Mbps is set to 50%, a container may be provided with performance of 10 Mbps.

In one embodiment, the host device may obtain a performance ratio between a plurality of containers from a user input. In addition, the host device may calculate the weights of the plurality of containers by calculating a percentage of network performance assurable in an entire network according to the performance ratio between the plurality of containers. For example, when performance ratios of 20% and 80% are respectively input for two containers, weights of the two containers may be converted into 1 and 4.

In a block 2003, the host device according to an embodiment may allocate the calculated resources to the plurality of containers. In one embodiment, the host device may periodically calculate and allocate credits, based on a performance control policy required by a network interface of containers.

In one embodiment, because the network performance of the plurality of containers is adjusted in proportion to the weights, the host device may control network bandwidth performance by adjusting the weights of the plurality of containers.

In a block 2004, the host device according to an embodiment may monitor the amount of resources used when services are provided by the plurality of containers. For example, when it is determined that credits allocated to a certain container are greater than or equal to a certain value, it may be determined that network usage of the container is low and all the allocated credits are not consumed.

In a block 2005, the host device according to an embodiment may dynamically recalculate resources to be allocated to the plurality of containers by reflecting the amount of resources used by the plurality of containers. For example, waste of network resources may be reduced by distributing resources already allocated to a container to another container.

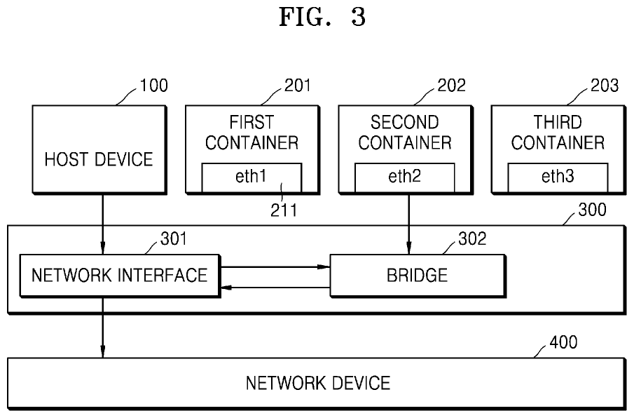

FIG. 3 is a diagram for explaining a container network mode in an Internet-of-Things (IoT) environment according to an embodiment.

One aspect of the disclosure is directed to dynamically allocating network resources by an IoT device to control network performance in units of containers. In one embodiment, the container network modes in an IoT environment according to one embodiment may implement a bridge mode and a host mode at the same time.

In one embodiment, a Linux network stack 300 may include a network interface 301 and a bridge 302 of a host.

In one embodiment, the bridge mode is a mode in which one bridge is shared by a plurality of containers, and in the bridge mode, a plurality of containers independently process packets by using a network stack, thereby enabling independent network operations.

In one embodiment, a first container 201, a second container 202, and a third container 203 may share a bridge 302. The first container 201, the second container 202, and the third container 203 may each include an independent network interface, a media access control (MAC) address, and an Internet protocol (IP) address. For example, the first container 201 may include a first network interface (eth1) 211. The second container 202 and the third container 302 may respectively include a second network interface (eth2) and a third network interface (eth3).

The bridge 302 is a link layer device and may transmit a packet to a network device by identifying a MAC address. In addition, the bridge 302 may transmit a packet by using information of an MAC address table created by receiving information of neighboring network devices through an address resolution protocol (ARP).

In one embodiment, in the host mode, packets of a plurality of containers may be processed at a time in the network interface 301 of the host. Therefore, a degradation in network performance does not occur due to an increase in load on the containers.

In one embodiment of the disclosure, network performance may be dynamically controlled using both the network interface 301 and the bridge 302 of the host. For example, when the first container 201 transmits a packet to the bridge 302 by using the first network interface 211, the bridge 302 may determine whether the first container 201 has resources sufficient to transmit the packet to a network device. The bridge 302 may transmit the packet to the network interface 301 only when a resource allocated to the first container 201 is larger than the size of the packet to be transmitted. In one embodiment, when the resource of the first container 201 is smaller than the size of the packet, the packet may not be transmitted to the network interface 301, thereby limiting network performance.

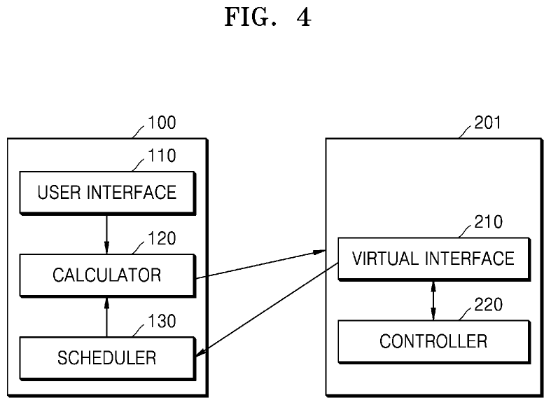

FIG. 4 is a diagram for explaining operations of a host device and a container device according to an embodiment.

In one embodiment, a host device 100 may include a user interface 110, a calculator 120, and a scheduler 130. In one embodiment, a first container device 201 may include a virtual interface 210 and a controller 220.

In one embodiment, the user interface 110 may receive a performance value for each container from a user. In one embodiment, the user interface 110 may input the performance value of each container as a ratio (%) of performance of each container to total network performance. In addition, the user interface 110 may input absolute values as a range of minimum and maximum values of performance of each container.

In one embodiment, resources may be dynamically allocated based on a performance range of each container received from the user interface 110, thereby using the resources according to a user's intention.

In one embodiment, operations of the calculator 120 and the scheduler 130 may be controlled by a processor of the host device 100. In one embodiment, the processor of the host device 100 may include at least one of a calculator and a scheduler.

In one embodiment, the calculator 120 and the scheduler 130 may operate as independent physical processors included in the host device 100. In addition, the calculator 120 and the scheduler 130 may be virtual components included in a processor of one host device 100. Operations of the calculator 120 and the scheduler 130 will be separately described below but operations to be described below may be executed by one processor.

In one embodiment, the calculator 120 may determine the resource allocation amount, based on a performance value set for each container. In one embodiment, the calculator 120 may calculate weights of a plurality of containers, based on a user input, and calculate resources to be allocated to the plurality of containers, based on the weights. In one embodiment, the calculator 120 may calculate the weights of the plurality of containers by obtaining a performance ratio between the plurality of containers from the user input and calculating a percentage of network performance assurable in an entire network according to the performance ratio between the plurality of containers. For example, the calculator 120 may determine a weight of the first container 201 as a first weight and a weight of the second container 202 as a second weight, based on the user input.

In one embodiment, the calculator 120 may allocate the calculated resources to the plurality of containers. In one embodiment, the calculator 120 may transmit a resource to the virtual interface 210 of the first container 201. The virtual interface 210 can transmit the allocated resource to the controller 220, and the controller 220 may operate the first container 201 by using the resource. In addition, the controller 220 may request the host 100 to additional provide a resource by using the virtual interface 210 when the first container 201 is difficult to operate with only the resource allocated to the first container 201.

In one embodiment, the calculator 120 may determine an absolute value of a minimum performance level, which is included in the user input, as a minimum value, and an absolute value of a maximum performance level, which is included in the user input, as a maximum value. In one embodiment, the calculator 120 may ensure relative network performance by allocating resources proportionally according to the weights, but it is difficult to satisfy a quantitative performance value when a user requests the quantitative performance value. Therefore, quantitative performance may be ensured to be within a range set by setting minimum performance and maximum performance of each container according to the user's request to ensure quantitative performance.

In one embodiment, the calculator 120 may calculate credits to be allocated to a plurality of containers. For example, a first credit may be calculated by adding a credit according to the first weight of the first container 201 and remaining credits of the first container 201. In this case, the calculator 120 may determine whether the first credit falls between the minimum value and the maximum value. In one embodiment, when the first credit falls between the minimum value and the maximum value, the calculator 120 may determine whether the first credit is less than a total credit. In one embodiment, when the first credit is less than the total credit, the first credit may be allocated to the first container 201.

In one embodiment, when the first credit allocated according to a weight is greater than the maximum value, the calculator 120 may determine the maximum value as a first-second credit. In one embodiment, the calculator 120 may allocate the first-second credit corresponding to a maximum performance value to the first container 201 and allocate a difference value obtained by subtracting the first-second credit from the first credit to another container. Accordingly, the calculator 120 may always maintain network performance of the first container 201 to be equal to or less than a maximum bandwidth.

In one embodiment, when the first credit is less than the minimum value, the calculator 120 may determine the minimum value as a first-third credit. The calculator 120 may allocate the first-third credit to the first container 201 to satisfy minimum performance of the first container 201. In this case, the calculator 120 may obtain a credit to be allocated to another container by subtracting the first credit from the first-third credit.

In one embodiment, when the first credit is greater than the total credit, the calculation unit 120 may estimate that the resource allocated to the first container 201 has not been used. In this case, the calculator 120 may not allocate the credit according to the first weight to the first container 201 and may distribute the credit to another container. Therefore, efficiency of network resource management may be increased.

In one embodiment, the scheduler 130 may monitor the amount of resources used when services are provided by a plurality of containers. In one embodiment, when a packet is received from the first container 201, the scheduler 130 may receive the packet from a bridge of a Linux kernel and transmit the packet to a network interface. In this case, the scheduler 130 may compare a size of the packet with the remaining credits of the first container 201 before transmitting the packet to the network interface. For example, when the size of the packet received from the first container 201 is less than the remaining credits of the first container 201, the scheduler 130 may subtract a credit for transmitting the packet from the remaining credits and transmit the packet to the network interface. In another embodiment, when the size of the packet received from the first container 201 is greater than the remaining credits of the first container 202, the scheduler 130 may release a memory of the packet received from the first container 201. In one embodiment, network performance of a malicious container that tries to exclusively use network resources may be limited to prevent excessive use of a limited amount of resources by an IoT device.

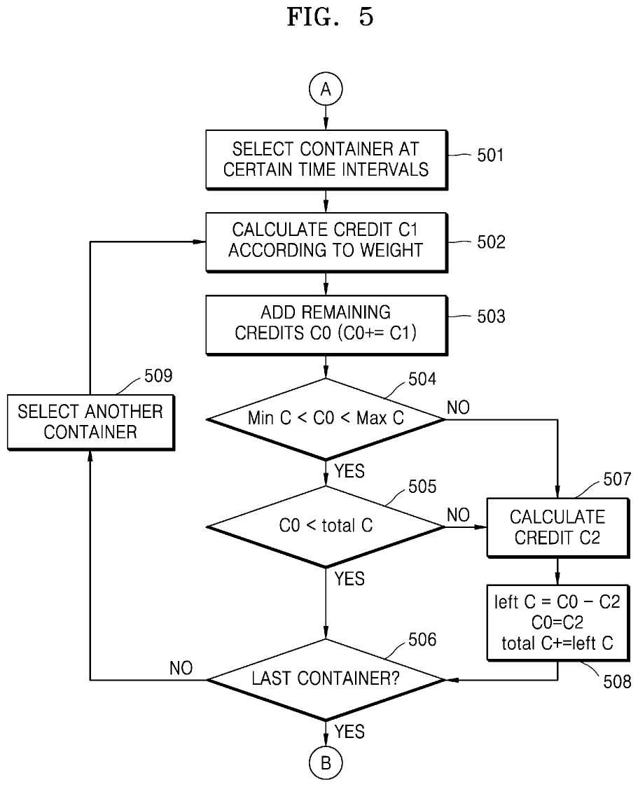

FIG. 5 is a flowchart of operations of a calculator to allocate credits according to an embodiment.

In one embodiment, the calculator 120 may calculate a scheduling policy, based on a current credit corresponding to a network interface of at least one container, and schedule a request for work for the at least one container, based on the calculated scheduling policy.

In a block 501, the calculator 120 according to an embodiment may select a container at certain time intervals. For example, the calculator 120 may periodically select a network interface of a container every 10 ms.

In a block 502, the calculator 120 according to an embodiment may calculate a credit C1, which is a resource of a network interface of the selected container. In this case, the credit C1 is a credit calculated according to a weight based on a user input.

In a block 503, the calculator 120 according to an embodiment may add remaining credits C0 together. In one embodiment, the calculator 120 may determine the remaining credits C0 by adding the calculated credit C1 to current remaining credits C0.

In a block 504, the calculator 120 according to an embodiment may determine whether the resultant remaining credits C0 satisfies a range of minimum and maximum values.

In a block 505, when the remaining credits C0 satisfy the range of the minimum value and the maximum value, the calculator 120 according to an embodiment may determine whether the remaining credits C0 are less than a total credit C of an entire system.

In a block 506, when the remaining credits C0 satisfy the range of minimum and maximum values, the calculator 120 according to an embodiment may end the process by determining whether a current network interface is a network interface of a last container when the remaining credits C0 are less than the total credit C of the entire system.

In a block 507, the calculator 120 according to an embodiment may recalculate a credit C2 when the remaining credits C0 do not fall within the range of a minimum value Min C and a maximum value Max C or is not equal to or less than the total credit C of the entire system.

In a block 508, the calculator 120 according to an embodiment may adjust the total credit C of the entire system to a credit CreditLeft by using the difference between a previously calculated remaining credits C0 and the recalculated credit C2. The calculator 120 may directly allocate the recalculated credit C2 without being added to the remaining credits C0, so that the recalculated credit C2 may be used as a network resource of the network interface of the container.

In a block 509, when a current container is not a last container, the calculator 120 according to an embodiment may select a subsequent container and repeatedly perform the above credit calculation process thereon. In one embodiment, the process may be repeatedly performed until credits of the network interfaces of all containers in the system are calculated and an entire algorithm may be executed every 10 ms.

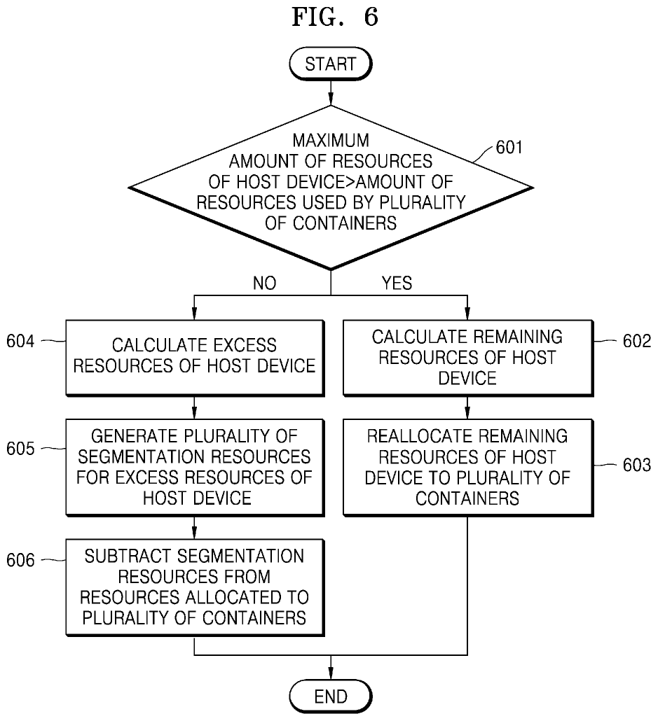

FIG. 6 is a flowchart of resource reallocation according to usage of resources of a container, according to an embodiment. In one embodiment, the host device 100 may dynamically reallocate resources by monitoring an actual amount of resources used by a plurality of containers.

In a block 601, the host device 100 according to an embodiment may determine whether a maximum amount of resources of the host device 100 is greater than the amount of resources used by the plurality of containers. In this case, the amount of resources used by the plurality of containers refers to the sum of the amounts of resources actually used by the plurality of containers.

In a block 602, when the maximum amount of resources of the host device 100 is greater than the amount of resources used by the plurality of containers, the host device 100 according to an embodiment may calculate remaining resources of the host device 100. In one embodiment, the host device 100 may calculate remaining resources thereof by subtracting the sum of the amounts of resources used by the plurality of containers from the maximum amount of resources of the host device 100.

In a block 603, the host device 100 according to an embodiment may reallocate the remaining resources thereof to the plurality of containers. In this case, the host device 100 may reallocate the remaining resources thereof according to a ratio between the amounts of resources used by the plurality of containers.

In a block 604, the host device 100 may determine that resources have been excessively used by the plurality of containers when the maximum amount of resources of the host device 100 is less than the amount of resources used by the plurality of containers. The host device 100 according to an embodiment may calculate excess resources thereof by subtracting the maximum amount of resources of the host device 100 from the sum of the amounts of resources used by the plurality of containers.

In a block 605, the host device 100 according to an embodiment may generate a plurality of segmentation resources for the excess resources of the host device 100 according to the ratio between the amounts of resources used by the plurality of containers.

In a block 606, the host device 100 according to an embodiment may subtract the plurality of segmentation resources from the resources allocated to the plurality of containers.

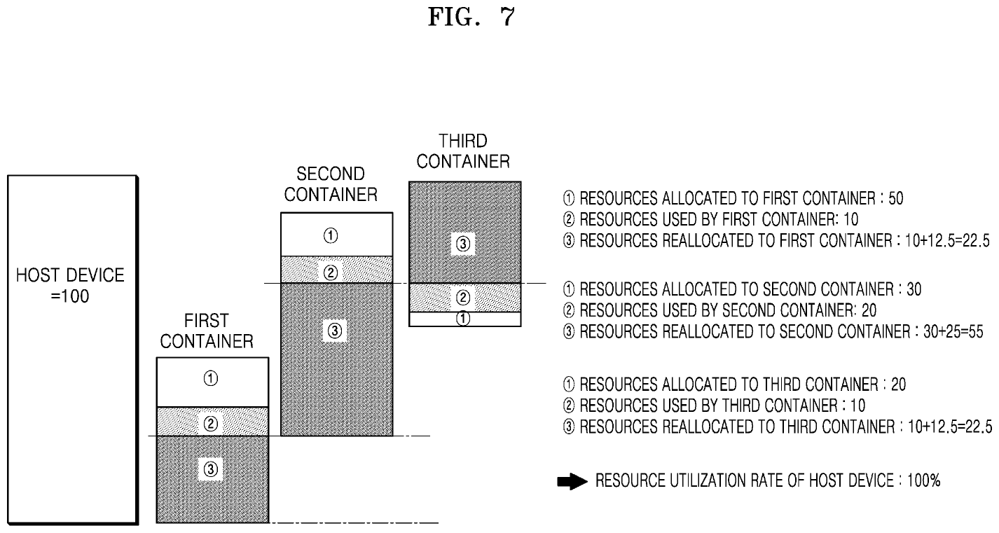

FIG. 7 is a diagram for explaining reallocation of resources when an amount of resources used by a plurality of containers is less than that of resources allocated to the plurality of containers, according to an embodiment.

In one embodiment, it is assumed that the amount of resources of the host device 100 is 100. In one embodiment, the host device 100 may allocate resources to a plurality of containers, based on a ratio of performance between the plurality of containers, a minimum value, and a maximum value according to a user input. For example, resources may be allocated at a ratio of 50:30:20 to a first container, a second container, and a third container.

In one embodiment, the host device 100 may monitor the actual amounts of resources used by the plurality of containers. In one embodiment, the host device 100 may confirm that the amounts of resources used by the first container, the second container, the third container are respectively 10, 20, and 30. An actual amount of resources used by the plurality of containers is 50 and the total amount of remaining resources is 50.

In one embodiment, the host device 100 may determine that a resource usage rate of the first container: a resource usage rate of the second container: a resource usage rate of the third container=1:2:1. The host device 100 may redistribute the total amount of remaining resources, i.e., 50, according to a resource usage rate.

In one embodiment, the host device 100 may reallocate the remaining resources at a ratio of 12.5:25:22.5 to the first container, the second container, and the third container. Therefore, resources may be allocated at a ratio of 22.5:55:22.5 to the first container, the second container, and the third container, thereby maintaining a resource usage rate of the host device 100 to be 100%.

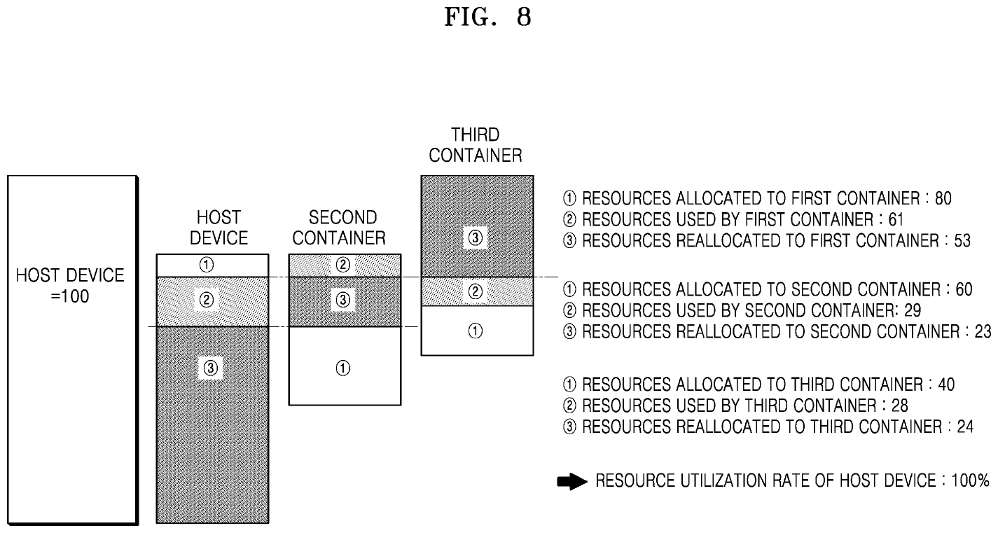

FIG. 8 is a diagram for explaining reallocation of resources when the amount of resources used by a plurality of containers is greater than that of resources allocated thereto, according to an embodiment.

In one embodiment, the host device 100 may allocate resources to a first container, a second container, and a third container at a ratio of 80:60:40, based on a weight of each of a plurality of containers, a minimum value, and a maximum value.

In one embodiment, although the amount of resources of the plurality of containers should not exceed a maximum amount of resources of the host device 100, the sum of the amounts of resources allocated to the plurality of containers may exceed the maximum amount of resources of the host device 100. Over-committing resources to a plurality of containers as described above is to increase efficiency of work processed by the plurality of containers, because the plurality of containers do not always operate using all resources. In one embodiment, the amount of resources allocated to and used by a plurality of virtualized containers is implemented in software within basic performance of the host device 100 according to the virtualization technology, and therefore, resources may be over-committed to a plurality of containers.

Because the plurality of virtualized containers should process data with an amount of initially allocated resources as an upper limit, the amounts of resources used by the plurality of virtualized containers do not exceed the amount of allocated resources.

However, as described above, for efficient data processing by a plurality of virtualized containers implemented in the host device 100, the sum of resources allocated of the plurality of containers may exceed the maximum amount of resources of the host device 100. Accordingly, there may be a case in which the sum of resources used by the plurality of containers exceed the maximum amount of resources of the host device 100. The amount of resources used by the plurality of containers, which is measured in this situation, is a value measured inside the plurality of containers. Thus, when a maximum value of the amount of resources of the host device 100 is limited, an actual amount of resources by the plurality of containers should be less than the value measured inside the plurality of containers.

In one embodiment, the host device 100 may estimate the amount of resources used by the plurality of containers. In one embodiment, the host device 100 may estimate that the amounts of resources to be used by the first container, the second container, and the third container are respectively 61, 29 and 28. The amount of resources estimated to be actually used by the plurality of containers is 118, and the amount of resources to be used greater than the total amount of resources is 18.

In one embodiment, the host device 100 may calculate a plurality of segmentation resources for excess resources in a ratio between the amounts of resources used by the plurality of containers. The host device 100 may calculate the segmentation resources as a ratio of 61:29:28.

In one embodiment, the host device 100 may reallocate resources to the plurality of containers by subtracting the segmentation resources from the resources allocated to the plurality of containers. For example, the host device 100 may reallocate resources to the first container, the second container, and the third container at a ratio of 53:23:24. In this case, a resource usage rate of the host device 100 is operated at 100%, thereby providing an effect of work preservation.

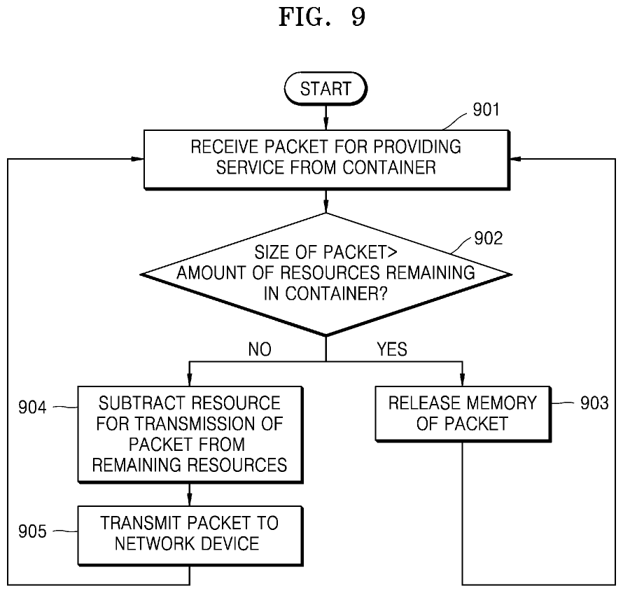

FIG. 9 is a diagram for explaining an operation of a scheduler according to an embodiment.

In a block 901, a scheduler according to an embodiment may receive a packet for providing a service from a container.

In a block 902, the scheduler according to an embodiment may compare a size of the packet with the amount of resources remaining in the container.

In a block 903, the scheduler according to an embodiment does not transmit the packet to a network device when the size of the packet is greater than the amount of remaining resources. The scheduler may release a memory of the packet to prevent exclusive use of resources by a certain container.

In a block 904, a resource for transmission of the packet may be subtracted from the resources remaining in the container in one embodiment.

In a block 905, the scheduler according to an embodiment may transmit the packet to the network device. In this case, the container may provide a service by using the resource.

A method and device for allocating resources in a virtualization environment are not limited to the configurations and methods of the embodiments described above, and various changes may be made in the embodiments through selective combination of the entire or part of the embodiments.

The computer system and the memory error detection method performed by the computer system described herein may be implemented by hardware components, software components, and/or a combination of the hardware and software components.

The software components may include a computer program, code, instructions, or a combination of one or more of them, and cause a processing device to operate as desired or send instructions independently or collectively to the processing device.

The software components may be embodied as a computer program including instructions stored in a computer-readable storage medium. The computer-readable recording medium may include, for example, a magnetic storage medium (e.g., ROM, random-access memory (RAM), a floppy disk, a hard disk, etc.) and an optical reading medium (e.g., a CD-ROM), a Digital Versatile Disc (DVD), and the like. The computer-readable recording medium may be distributed over network coupled computer systems so that computer readable code may be stored and executed in a distributed fashion. The computer-readable recording medium is readable by a computer, stored in memory, and executed by a processor.

The computer-readable storage medium may be provided as a non-transitory storage medium. Here, the term “non-temporary” means that the storage medium does not include a signal and is tangible but does not indicate whether data is stored in the storage medium semi-permanently or temporarily.

The computer system and the memory error detection method performed by the computer system according to the embodiments set forth herein may be provided in a computer program product. The computer program product may be traded as a product between a seller and a purchaser.

The computer program product may include a software program and a computer-readable storage medium storing the software program. For example, the computer program product may include a product (e.g., a downloadable application) in the form of a software program electronically distributed through a manufacturer of an electronic device or an electronic market (e.g., Google Play Store or App Store). For electronic distribution of the software program, at least part of the software program may be stored in a storage medium or temporarily generated. In this case, the storage medium may be a storage medium of a server of the manufacturer, a server of the electronic market, or a storage medium of a relay server that temporarily stores the software program.

The computer program product may include a storage medium of a server or a storage medium of a user equipment (UE) in a system consisting of the server and the UE (e.g., an ultrasonic diagnostic device). Alternatively, when there is a third device (e.g., a smart phone) capable of establishing communication with the server or the UE, the computer program product may include a storage medium of the third device. Alternatively, the computer program product may include a software program transmitted from the server to the UE or the third device or transmitted from the third device to the UE.

In this case, the server, the UE, or the third device may execute the computer program product to perform the methods according to the embodiments set forth herein. Alternatively, two or more among the server, the UE, and the third device may execute the computer program product to perform the methods according to the embodiments set forth herein in a distributed manner.

For example, the server (e.g., a cloud server or an artificial intelligence server) may execute the computer program product stored in the server to control the UE communicatively connected thereto to perform the methods according to the embodiments set forth herein.

As another example, the third device may execute the computer program product to control the UE communicatively connected thereto to perform the methods according to the embodiments set forth herein.

When the third device executes the computer program product, the third device may download the computer program product from the server and execute the downloaded computer program product. Alternatively, the third device may execute the computer program product provided in a preloaded state to perform the methods according to the embodiments set forth herein.

Although embodiments have been described above in conjunction with the limited number of embodiments and the drawings, various modifications and modifications can be made from the above description by those of ordinary skill in the art. For example, an appropriate result can be achieved even when the above- described techniques are performed in an order different from that described herein and/or when the above-described components such as computer systems or modules are combined in a form different from that described herein or replaced with other components.

1. A host device for dynamically allocating resources to a plurality of virtualized containers, the host device comprising:
a user interface configured to receive a user input requesting to allocate resources to the plurality of containers;
a calculator configured to calculate weights of the plurality of containers, based on the user input, calculate the resources to be allocated to the plurality of containers, based on the weights, allocate the calculated resources to the plurality of containers, and dynamically recalculate resources to be allocated to the plurality of containers by reflecting amounts of resources used by the plurality of containers; and
a scheduler configured to monitor an amount of resources used when services are provided by the plurality of containers.

2. The host device of claim 1, wherein the calculator calculates the weights of the plurality of containers by obtaining a performance ratio between the plurality of containers from the user input and calculating a percentage of network performance assurable in an entire network according to the performance ratio between the plurality of containers.

3. The host device of claim 1, wherein the calculator determines an absolute value of minimum performance, which is included in the user input, as a minimum value, and
an absolute value of maximum performance, which is included in the user input, as a maximum value.

4. The host device of claim 2, wherein the calculator
calculates a first credit by adding a credit according to a first weight of a first container and remaining credits of the first container,
determines whether the first credit is between a minimum value and a maximum value,
determines whether the first credit is less than a total credit when the first credit is between the minimum value and the maximum value, and
allocates the first credit to the first container when the first credit is less than the total credit.

5. The host device of claim 4, wherein the calculator
determines the maximum value as a first-second credit and allocates the difference between the first-second credit and the first credit to another container, when the first credit is greater than the maximum value, and
determines the minimum value as a first-third credit and allocates the first-third credit to the first container, when the first credit is less than the minimum value.

6. The host device of claim 4, wherein the calculator allocates the credit according to the first weight to another container rather than the first container when the first credit is greater than the total credit.

7. The host device of claim 1, wherein the scheduler
subtracts a credit for packet transmission from remaining credits of the first container and transmits a packet received from the first container to a network device, when a size of the packet is less than the remaining credits of the first container, and
releases a memory of the packet received from the first container when the size of the packet received from the first container is greater than the remaining credits of the first container.

8. The host device of claim 1, wherein the calculator
calculates remaining resources of the host device by subtracting the sum of the amounts of resources used by the plurality of containers from a maximum amount of resources of the host device, and
reallocates the remaining resources of the host device according to a ratio between the amounts of resources used by the plurality of containers.

9. The host device of claim 1, wherein the calculator
calculates excess resources of the host device by subtracting a maximum amount of resources of the host device from the sum of the amounts of resources used by the plurality of containers,
generates a plurality of segmentation resources for the excess resources of the host device according to a ratio between the amounts of resources used by the plurality of containers, and
subtracts the plurality of segmentation resources from the resources allocated to the plurality of containers.

10. The host device of claim 1, wherein, when the host device creates a new container, the user interface receives a user input including a percentage of a performance ratio of the new container, an absolute value of minimum performance of the new container, and an absolute value of maximum performance of the new container.

11. A method of dynamically allocating resources by a host device including a plurality of virtualized containers, the method comprising:
receiving a user input requesting to allocate resources to the plurality of containers;
calculating weights of the plurality of containers, based on the user input, and calculating the resources to be allocated to the plurality of containers, based on the weights;
allocating the calculated resources to the plurality of containers;
monitoring an amount of resources used when services are provided by the plurality of containers; and
dynamically recalculating resources to be allocated to the plurality of containers by reflecting amounts of resources used by the plurality of containers.

12. The method of claim 11, wherein the calculating of the weights of the plurality of containers comprises:
obtaining a performance ratio between the plurality of containers from the user input; and
calculating the weights of the plurality of containers by calculating a percentage of network performance assurable in an entire network according to the performance ratio between the plurality of containers.

13. The method of claim 11, wherein the calculating of the weights of the plurality of containers comprises:
determining an absolute value of minimum performance, which is included in the user input, as a minimum value; and
determining an absolute value of maximum performance, which is included in the user input, as a maximum value.

14. The method of claim 12, further comprising:
calculating a first credit by adding a credit according to a first weight of a first container and remaining credits of the first container;
determining whether the first credit is between a minimum value and a maximum value;
determining whether the first credit is less than a total credit when the first credit is between the minimum value and the maximum value; and
allocating the first credit to the first container when the first credit is less than the total credit.

15. The method of claim 14, further comprising:
determining the maximum value as a first-second credit and allocating the difference between the first-second credit and the first credit to another container, when the first credit is greater than the maximum value; and
determining the minimum value as a first-third credit and allocating the first-third credit to the first container, when the first credit is less than the minimum value.

16. The method of claim 14, further comprising, when the first credit is greater than the total credit, allocating the credit according to the first weight to another container rather than the first container.

17. The method of claim 11, further comprising:
subtracting a credit for packet transmission from remaining credits of the first container and transmitting a packet received from the first container to a network device, when a size of the packet is less than the remaining credits of the first container; and
releasing a memory of the packet received from the first container when the size of the packet received from the first container is greater than the remaining credits of the first container.

18. The method of claim 11, wherein the monitoring of the amount of resources used when the services are provided by the plurality of containers comprises:
calculating remaining resources of the host device by subtracting the sum of the amounts of resources used by the plurality of containers from a maximum amount of resources of the host device; and
reallocating the remaining resources of the host device according to a ratio between the amounts of resources used by the plurality of containers.

19. The method of claim 11, wherein the dynamic recalculating of the resources to be allocated to the plurality of containers comprises:
calculating excess resources of the host device by subtracting a maximum amount of resources of the host device from the sum of the amounts of resources used by the plurality of containers;
generating a plurality of segmentation resources for the excess resources of the host device according to a ratio between the amounts of resources by the plurality of containers; and
subtracting the plurality of segmentation resources from the resources allocated to the plurality of containers.

20. A computer program product comprising a recording medium storing a program to perform:
receiving a user input requesting to allocate resources to a plurality of containers;
calculating weights of the plurality of containers, based on the user input, and calculating the resources to be allocated to the plurality of containers, based on the weights;
allocating the calculated resources to the plurality of containers;
monitoring an amount of resources used when services are provided by the plurality of containers; and
dynamically recalculating resources to be allocated to the plurality of containers by reflecting amounts of resources used by the plurality of containers.
